(19) United States
(12) Patent Application Publication
(10) Pub. No.: US 2025/0083098 A1
(43) Pub. Date: Mar. 13, 2025

(54) METHOD OF OPERATING SEPARATION APPARATUS AND SEPARATION APPARATUS

(71) Applicant: NGK INSULATORS, LTD., Nagoya-City (JP)

(72) Inventors: Koh KOBAYASHI, Nagoya-Shi (JP); Aya MIURA, Kariya-Shi (JP)

(73) Assignee: NGK INSULATORS, LTD., Nagoya-City (JP)

(21) Appl. No.: 18/960,001

(22) Filed: Nov. 26, 2024

Related U.S. Application Data
(63) Continuation of application No. PCT/JP2023/017076, filed on May 1, 2023.

(30) Foreign Application Priority Data
Jun. 8, 2022 (JP) 2022-092971

(51) Int. Cl. B01D 53/22; B01D 71/02

(52) U.S. Cl. CPC B01D 53/228; B01D 71/0281; B01D 2256/245; B01D 2257/504

(57) ABSTRACT

A method of operating a separation apparatus using a separation membrane includes a step of performing a normal operation for supplying a mixed gas containing a plurality of types of gases to a separation membrane at a constant set pressure, to thereby separate a substance in the mixed gas, which has high permeability through the separation membrane, from any other substance and a step of performing a high pressure treatment for supplying the mixed gas to the separation membrane at a pressure higher than the set pressure at the time of starting supply of the mixed gas to the separation membrane before the normal operation or in the middle of the normal operation.

### CROSS-REFERENCE TO RELATED APPLICATIONS

The present application is a continuation application of International Application No. PCT/JP2023/17076 filed on May 1, 2023, which claims priority to Japanese Patent Application No. 2022-092971 filed on Jun. 8, 2022. The contents of these applications are incorporated herein by reference in their entirety.

### TECHNICAL FIELD

The present invention relates to a method of operating a separation apparatus and the separation apparatus.

### BACKGROUND ART

Conventionally, considered is a method of improving permeability of a separation membrane. Japanese Patent Application Laid Open Gazette No. 2012-236123 (Document 1) discloses a method of obtaining high permeability of carbon dioxide by heat-drying crystal water of a FAU-type zeolite membrane at a temperature of 100 to 600° C. to remove the crystal water and then keeping the dry condition. Further, International Publication WO 2018/180210 (Document 2) discloses a method of reproducing a zeolite membrane. In this method, a zeolite membrane with which hydrocarbon mixture is brought into contact is pressurized, being exposed to an inert gas atmosphere, and then the temperature of the atmosphere is raised. In a method of reproducing a separation membrane module disclosed in Japanese Patent Application Laid Open Gazette No. 2018-183756 (Document 3), a raw material mixed gas is supplied to the separation membrane module to be thereby separated into a permeate gas and a non-permeate gas, and the permeate gas is supplied to the separation membrane module or another separation membrane module in a state where the supply of the raw material mixed gas is stopped to thereby remove impurities deposited onto a hollow fiber membrane.

From the manufacture of the separation membrane to the actual use thereof, the separation membrane is usually transported. Further, until being used, the separation membrane is sometimes stored for a long time. During the transport or the long-time storage, unnecessary substances such as moisture and hydrocarbon components or the like in the air are deposited onto the separation membrane and some pores of the separation membrane are closed, the permeability of the separation membrane is thereby sometimes reduced. In the case where the unnecessary substances are removed by heating, like in Document 1, a heater is needed. Further, there is a possibility that the life of the separation membrane may be consumed by heating at a high temperature. In the case where heating or pressurization is performed by using an inert gas, like in Document 2, a heater is needed like in the above-described case and further the inert gas needs to be prepared. In the case where the separation membrane is reproduced by using a permeate gas which has permeated the separation membrane, like in Document 3, two lines (series) each including the separation membrane are needed, and the apparatus is thereby upsized and space and cost increase.

### SUMMARY OF THE INVENTION

It is an object of the present invention to easily improve permeability of a separation membrane.

A first aspect of the present invention is a method of operating a separation apparatus using a separation membrane, which includes a step of performing a normal operation for supplying a mixed gas containing a plurality of types of gases to a separation membrane at a constant set pressure, to thereby separate a substance in the mixed gas, which has high permeability through the separation membrane, from any other substance and a step of performing a high pressure treatment for supplying the mixed gas to the separation membrane at a pressure higher than the set pressure at a time of starting supply of the mixed gas to the separation membrane before the normal operation or in a middle of the normal operation.

According to the present invention, it is possible to remove unnecessary substances deposited onto the separation membrane and easily improve the permeability of the separation membrane.

A second aspect of the present invention is the method of operating a separation apparatus of the first aspect, in which in a case where a relation between a ratio A of an applied pressure to a breakdown pressure and a life time L at the applied pressure in the separation membrane is expressed as log₁₀ L=a log₁₀ A+b, values of a and b are obtained in advance, and a life consumption rate [%] in one high pressure treatment, which is obtained by substituting a ratio of a pressure during the high pressure treatment to the breakdown pressure for A in a following equation using the values of a and b and substituting a time for the high pressure treatment for t, is not higher than 0.1%.

$$( Eq . 1 )$$

$$life consumption rate in one high pressure treatment = \frac{t}{{A}^{a} \times {10}^{b}} \times 100$$

A third aspect of the present invention is the method of operating a separation apparatus of the first or second aspect, in which the set pressure is 0.1 to 8 MPaG, and the pressure during the high pressure treatment is not higher than 10 times the set pressure.

A fourth aspect of the present invention is the method of operating a separation apparatus of any one of the first to third aspects, in which the time for the high pressure treatment is 0.1 to 10000 seconds.

A fifth aspect of the present invention is the method of operating a separation apparatus of any one of the first to fourth aspects, in which the separation membrane is a zeolite membrane.

A sixth aspect of the present invention is the method of operating a separation apparatus of the fifth aspect, in which the maximum number of membered rings of a zeolite forming the zeolite membrane is 8.

A seventh aspect of the present invention is a separation apparatus, which includes a separation membrane, a supply part for supplying a mixed gas containing a plurality of types of gases to the separation membrane, to thereby separate a substance in the mixed gas, which has high permeability through the separation membrane, from any other substance, and a control part for controlling the supply part to perform a normal operation for supplying the mixed gas to the separation membrane at a constant set pressure and perform a high pressure treatment for supplying the mixed gas to the separation membrane at a pressure higher than the set pressure at a time of starting supply of the mixed gas to the separation membrane before the normal operation or in a middle of the normal operation.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a view showing a configuration of a separation apparatus;

FIG. 2 is a cross-sectional view showing a zeolite membrane complex;

FIG. 3 is a cross-sectional view enlargedly showing part of the zeolite membrane complex; and

FIG. 4 is a flowchart showing a flow of operating the separation apparatus.

### DETAILED DESCRIPTION

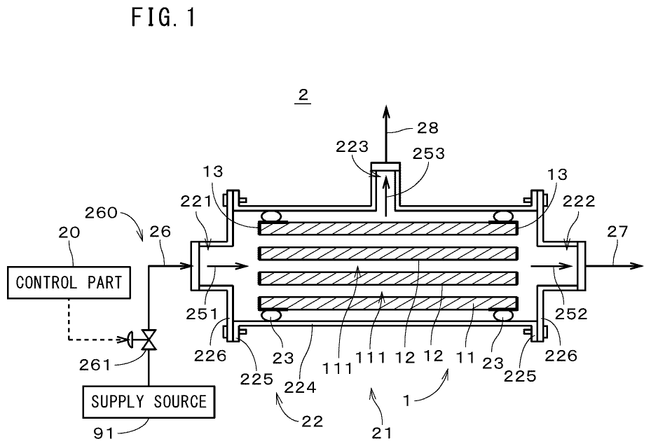

FIG. 1 is a view showing a configuration of a separation apparatus 2 in accordance with one preferred embodiment of the present invention. In FIG. 1, parallel hatch lines are omitted in the cross section of some constituent elements. The separation apparatus 2 is an apparatus for separating a substance (high permeability substance) with high permeability through a later-described zeolite membrane 12 from a mixed gas containing a plurality of types of gases. Separation in the separation apparatus 2 may be performed, for example, in order to extract a substance with high permeability from the mixed gas, or in order to concentrate a substance with low permeability.

The mixed gas contains at least one type of, for example, hydrogen (H₂), helium (He), nitrogen (N₂), oxygen (O₂), water (H₂O), carbon monoxide (CO), carbon dioxide (CO₂), nitrogen oxide, ammonia (NH₃), sulfur oxide, hydrogen sulfide (H₂S), sulfur fluoride, mercury (Hg), arsine (AsH₃), hydrogen cyanide (HCN), carbonyl sulfide (COS), C1 to C8 hydrocarbons, organic acid, alcohol, mercaptans, ester, ether, ketone, and aldehyde. The above-described high permeability substance is at least one type of, for example, H₂, N₂, O₂, H₂O, CO₂, and H₂S.

The nitrogen oxide is a compound of nitrogen and oxygen. The above-described nitrogen oxide is, for example, a gas called NO_{X} such as nitric oxide (NO), nitrogen dioxide (NO₂), nitrous oxide (also referred to as dinitrogen monoxide) (N₂O), dinitrogen trioxide (N₂O₃), dinitrogen tetroxide (N₂O₄), dinitrogen pentoxide (N₂O₅), or the like.

The sulfur oxide is a compound of sulfur and oxygen. The above-described sulfur oxide is, for example, a gas called SO_{X} such as sulfur dioxide (SO₂), sulfur trioxide (SO₃), or the like.

The sulfur fluoride is a compound of fluorine and sulfur. The above-described sulfur fluoride is, for example, disulfur difluoride (F—S—S—F, S═SF₂), sulfur difluoride (SF₂), sulfur tetrafluoride (SF₄), sulfur hexafluoride (SF₆), disulfur decafluoride (S₂F₁₀), or the like.

The C1 to C8 hydrocarbons are hydrocarbons with not less than 1 and not more than 8 carbon atoms. The C3 to C8 hydrocarbons may be any one of a linear-chain compound, a side-chain compound, and a ring compound. Further, the C2 to C8 hydrocarbons may either be a saturated hydrocarbon (i.e., in which there is no double bond or triple bond in a molecule), or an unsaturated hydrocarbon (i.e., in which there is a double bond and/or a triple bond in a molecule). The C1 to C4 hydrocarbons are, for example, methane (CH₄), ethane (C₂H₆), ethylene (C₂H₄), propane (C₃H₈), propylene (C₃H₆), normal butane (CH₃(CH₂)₂CH₃), isobutane (CH(CH₃)₃), 1-butene (CH₂═CHCH₂CH₃), 2-butene (CH₃CH═CHCH₃), or isobutene (CH₂═C(CH₃)2).

The above-described organic acid is carboxylic acid, sulfonic acid, or the like. The carboxylic acid is, for example, formic acid (CH₂O₂), acetic acid (C₂H₄O₂), oxalic acid (C₂H₂O₄), acrylic acid (C₃H₄O₂), benzoic acid (C₆H₅COOH), or the like. The sulfonic acid is, for example, ethanesulfonic acid (C₂H₆O₃S) or the like. The organic acid may either be a chain compound or a ring compound.

The above-described alcohol is, for example, methanol (CH₃OH), ethanol (C₂H₅OH), isopropanol (2-propanol) (CH₃CH(OH)CH₃), ethylene glycol (CH₂(OH)CH₂(OH)), butanol (C₄H₉OH), or the like.

The mercaptans are an organic compound having hydrogenated sulfur (SH) at the terminal end thereof, and are a substance also referred to as thiol or thioalcohol. The above-described mercaptans are, for example, methyl mercaptan (CH₃SH), ethyl mercaptan (C₂H₅SH), 1-propanethiol (C₃H₇SH), or the like.

The above-described ester is, for example, formic acid ester, acetic acid ester, or the like.

The above-described ether is, for example, dimethyl ether ((CH₃)₂O), methyl ethyl ether (C₂H₅OCH₃), diethyl ether ((C₂H₅)₂O), or the like.

The above-described ketone is, for example, acetone ((CH₃)₂CO), methyl ethyl ketone (C₂H₅COCH₃), diethyl ketone ((C₂H₅)₂CO), or the like.

The above-described aldehyde is, for example, acetaldehyde (CH₃CHO), propionaldehyde (C₂H₅CHO), butanal (butylaldehyde) (C₃H₇CHO), or the like.

The separation apparatus 2 shown in FIG. 1 includes a separation membrane module 21, a supply pipe 26, a first collection pipe 27, and a second collection pipe 28. The separation membrane module 21 includes a zeolite membrane complex 1, a housing 22, and the two sealing members 23. The zeolite membrane complex 1 and the sealing members 23 are housed in the housing 22. The supply pipe 26, the first collection pipe 27, and the second collection pipe 28 are arranged outside the housing 22 and connected to the housing 22.

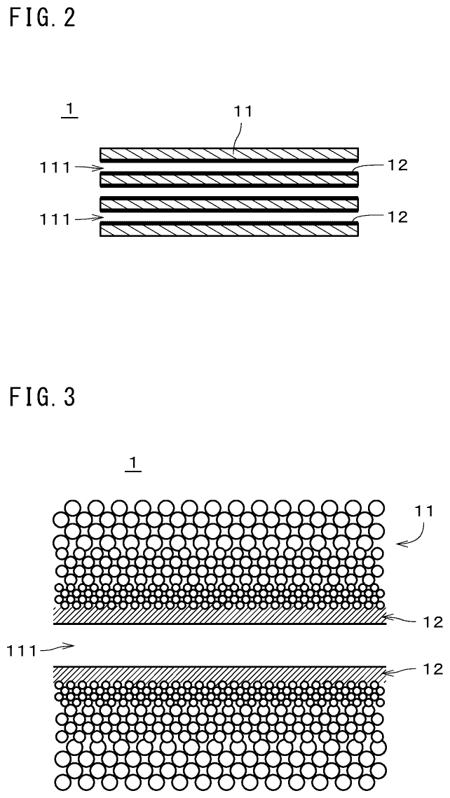

FIG. 2 is a cross-sectional view showing the zeolite membrane complex 1. FIG. 3 is a cross-sectional view enlargedly showing part of the zeolite membrane complex 1. In FIG. 2, a sealing part 13 described later is not shown. The zeolite membrane complex 1 is a separation membrane complex, and includes a porous support 11 and a zeolite membrane 12 which is a separation membrane formed on the support 11. The zeolite membrane 12 is at least obtained by forming zeolite on a surface of the support 11 in a membrane form and does not include a membrane obtained by simply dispersing zeolite particles in an organic membrane. Further, the zeolite membrane 12 may contain two or more types of zeolites which are different in the structure and the composition. In FIG. 2, the zeolite membrane 12 is represented by a thick line. In FIG. 3, the zeolite membrane 12 is hatched. Further, in FIG. 3, the thickness of the zeolite membrane 12 is shown larger than the actual thickness.

Furthermore, in the separation apparatus 2, a separation membrane complex other than the zeolite membrane complex 1 may be used, and instead of the zeolite membrane 12, an inorganic membrane formed of an inorganic substance other than zeolite or a membrane other than the inorganic membrane may be formed on the support 11 as the separation membrane. Further, a separation membrane in which zeolite particles are dispersed in an organic membrane may be used. In the following description, it is assumed that the separation membrane is the zeolite membrane 12.

The support 11 is a porous member that gas and liquid can permeate. In the exemplary case shown in FIG. 2, the support 11 is a monolith-type support having an integrally and continuously molded columnar main body provided with a plurality of through holes 111 extending in a longitudinal direction (i.e., a left and right direction in FIG. 2). In the exemplary case shown in FIG. 2, the support 11 has a substantially columnar shape. A cross section perpendicular to the longitudinal direction of each of the through holes 111 (i.e., cells) is, for example, substantially circular. In FIG. 2, the diameter of each through hole 111 is larger than the actual diameter, and the number of through holes 111 is smaller than the actual number. The zeolite membrane 12 is formed on an inner surface of each through hole 111, covering substantially the entire inner surface of the through hole 111.

The length of the support 11 (i.e., the length in the left and right direction of FIG. 2) is, for example, 10 cm to 200 cm. The outer diameter of the support 11 is, for example, 0.5 cm to 30 cm. The distance between the central axes of adjacent through holes 111 is, for example, 0.3 mm to 10 mm. The surface roughness (Ra) of the support 11 is, for example, 0.1 μm to 5.0 μm, and preferably 0.2 μm to 2.0 μm. Further, the shape of the support 11 may be, for example, honeycomb-like, flat plate-like, tubular, cylindrical, columnar, polygonal prismatic, or the like. When the support 11 has a tubular or cylindrical shape, the thickness of the support 11 is, for example, 0.1 mm to 10 mm.

As the material for the support 11, various materials (for example, ceramics or a metal) may be adopted only if the materials ensure chemical stability in the process step of forming the zeolite membrane 12 on the surface thereof. In the present preferred embodiment, the support 11 is formed of a ceramic sintered body. Examples of the ceramic sintered body which is selected as a material for the support 11 include alumina, silica, mullite, zirconia, titania, yttria, silicon nitride, silicon carbide, and the like. In the present preferred embodiment, the support 11 contains at least one type of alumina, silica, and mullite.

The support 11 may contain an inorganic binder. As the inorganic binder, at least one of titania, mullite, easily sinterable alumina, silica, glass frit, a clay mineral, and easily sinterable cordierite can be used.

The average pore diameter of the support 11 is, for example, 0.01 μm to 70 μm, and preferably 0.05 μm to 25 μm. The average pore diameter of the support 11 in the vicinity of the surface on which the zeolite membrane 12 is formed is 0.01 μm to 1 μm, and preferably 0.05 μm to 0.5 μm. The average pore diameter can be measured by using, for example, a mercury porosimeter, a perm porometer, or a nano-perm porometer. Regarding the pore diameter distribution of the entire support 11 including the surface and the inside thereof, D5 is, for example, 0.01 μm to 50 μm, D50 is, for example, 0.05 μm to 70 μm, and D95 is, for example, 0.1 μm to 2000 μm. The porosity of the support 11 in the vicinity of the surface on which the zeolite membrane 12 is formed is, for example, 20% to 60%.

The support 11 has, for example, a multilayer structure in which a plurality of layers with different average pore diameters are layered in a thickness direction. The average pore diameter and the sintered particle diameter in a surface layer including the surface on which the zeolite membrane 12 is formed are smaller than those in layers other than the surface layer. The average pore diameter in the surface layer of the support 11 is, for example, 0.01 μm to 1 μm, and preferably 0.05 μm to 0.5 μm. When the support 11 has a multilayer structure, the materials for the respective layers can be those described above. The materials for the plurality of layers constituting the multilayer structure may be the same as or different from one another.

The zeolite membrane 12 is a porous membrane having micropores. The zeolite membrane 12 can be used as a separation membrane for separating a specific substance from a fluid in which a plurality of types of substances are mixed, by using a molecular sieving function. As compared with the specific substance, any one of the other substances is harder to permeate the zeolite membrane 12. In other words, the permeance of any other substance through the zeolite membrane 12 is smaller than that of the above specific substance.

The thickness of the zeolite membrane 12 is, for example, 0.05 μm to 30 μm, preferably 0.1 μm to 20 μm, and further preferably 0.5 μm to 10 μm. When the thickness of the zeolite membrane 12 is increased, the separation performance increases. When the thickness of the zeolite membrane 12 is reduced, the permeance increases. The surface roughness (Ra) of the zeolite membrane 12 is, for example, 5 μm or less, preferably 2 μm or less, more preferably 1 μm or less, and further preferably 0.5 μm or less.

The pore diameter of the zeolite membrane 12 is, for example, 1 nm or less. The pore diameter of the zeolite membrane 12 is preferably not smaller than 0.2 nm and not larger than 0.8 nm, more preferably not smaller than 0.3 nm and not larger than 0.7 nm, and further preferably not smaller than 0.3 nm and not larger than 0.45 nm. When the pore diameter is larger than 1 nm, the separation performance is sometimes reduced. Further, when the pore diameter is smaller than 0.2 nm, the permeance is sometimes reduced. The pore diameter of the zeolite membrane 12 is smaller than the average pore diameter of the support 11 in the vicinity of the surface on which the zeolite membrane 12 is formed.

When the maximum number of membered rings of the zeolite forming the zeolite membrane 12 is n, the short diameter of an n-membered ring pore is defined as the pore diameter. Further, when the zeolite has a plurality of types of n-membered ring pores having the same n, the short diameter of the n-membered ring pore having the largest short diameter is defined as the pore diameter of the zeolite membrane 12. The n-membered ring pore refers to a pore in which the number of oxygen atoms in the part where the oxygen atoms and later-described T atoms are bonded to form a ring structure is n. Thus, the pore diameter of the zeolite membrane is uniquely determined depending on the framework structure of the zeolite and can be obtained from values disclosed in “Database of Zeolite Structures” [online], internet <URL: http://www.iza-structure.org/databases/> of the International Zeolite Association.

There is no particular limitation on the type of the zeolite forming the zeolite membrane 12, but the zeolite membrane 12 may be formed of, for example, AEI-type, AEN-type, AFN-type, AFV-type, AFX-type, BEA-type, CHA-type, DDR-type, ERI-type, ETL-type, FAU-type (X-type, Y-type), GIS-type, LEV-type, LTA-type, MEL-type, MFI-type, MOR-type, PAU-type, RHO-type, SAT-type, SOD-type zeolite, or the like.

The zeolite membrane 12 contains, for example, silicon (Si). The zeolite membrane 12 may contain, for example, any two or more of Si, aluminum (Al), and phosphorus (P). In this case, as the zeolite forming the zeolite membrane 12, zeolite in which atoms (T-atoms) each located at the center of an oxygen tetrahedron (TO₄) constituting the zeolite include only Si or Si and Al, AlPO-type zeolite in which T-atoms include Al and P, SAPO-type zeolite in which T-atoms include Si, Al, and P, MAPSO-type zeolite in which T-atoms include magnesium (Mg), Si, Al, and P, ZnAPSO-type zeolite in which T-atoms include zinc (Zn), Si, Al, and P, or the like can be used. Some of the T-atoms may be replaced by other elements.

When the zeolite membrane 12 contains Si atoms and Al atoms, the ratio of Si/Al in the zeolite membrane 12 is, for example, not less than 1 and not more than 100,000. The Si/Al ratio is preferably 5 or more, more preferably 20 or more, and further preferably 100 or more. In short, the higher the ratio is, the better. By adjusting the mixing ratio of an Si source and an Al source in a later-described starting material solution, or the like, it is possible to adjust the Si/Al ratio in the zeolite membrane 12. The zeolite membrane 12 may contain an alkali metal. The alkali metal is, for example, sodium (Na) or potassium (K).

From the viewpoints of an increase in the permeance of CO₂ and an improvement in the separation performance, it is preferable that the maximum number of membered rings of the zeolite should be 8. The zeolite membrane 12 is formed of, for example, DDR-type zeolite. In other words, the zeolite membrane 12 is a zeolite membrane formed of the zeolite having a structure code of “DDR” which is designated by the International Zeolite Association. In this case, the unique pore diameter of the zeolite forming the zeolite membrane 12 is 0.36 nm×0.44 nm, and the pore diameter is 0.36 nm.

The permeance of CO₂ through the zeolite membrane 12 at 20° C. to 400° C. is, for example, 100 nmol/m²·s·Pa or more. Further, the ratio (permeance ratio) of the permeance of CO₂ through the zeolite membrane 12 to the leakage (amount) of CH₄ at 20° C. to 400° C. is, for example, 100 or more. The permeance and the permeance ratio are those in a case where the partial pressure difference of CO₂ between the supply side and the permeate side of the zeolite membrane 12 is 1.5 MPa.

Herein, an exemplary flow for producing the zeolite membrane complex 1 will be described. In the production of the zeolite membrane complex 1, first, seed crystals to be used for producing the zeolite membrane 12 are prepared. As to the seed crystals, for example, DDR-type zeolite powder is synthesized by hydrothermal synthesis, and the seed crystals are acquired from the zeolite powder. The zeolite powder itself may be used as the seed crystals, or may be processed by pulverization or the like, to thereby acquire the seed crystals.

Subsequently, the porous support 11 is immersed in a dispersion liquid in which the seed crystals are dispersed, and the seed crystals are thereby deposited onto the support 11. Alternatively, the dispersion liquid in which the seed crystals are dispersed is brought into contact with a portion on the support 11 where the zeolite membrane 12 is to be formed, and the seed crystals are thereby deposited onto the support 11. A support with seed crystals deposited is thereby produced. The seed crystals may be deposited onto the support 11 by any other method.

The support 11 on which the seed crystals are deposited is immersed in a starting material solution. The starting material solution is produced, for example, by dissolving or dispersing an Si source and a structure-directing agent (hereinafter, also referred to as an “SDA”), and the like in a solvent. As the solvent of the starting material solution, for example, used is water or alcohol such as ethanol or the like. The SDA contained in the starting material solution is, for example, an organic substance. As the SDA, for example, 1-aminoadamantane can be used.

Then, the DDR-type zeolite is caused to grow from the seed crystals as a nucleus by the hydrothermal synthesis, to thereby form the DDR-type zeolite membranes 12 on the support 11. The temperature in the hydrothermal synthesis is preferably 120 to 200° C. The time for hydrothermal synthesis is preferably 5 to 100 hours.

After the hydrothermal synthesis is finished, the support 11 and the zeolite membrane 12 are washed with pure water. The support 11 and the zeolite membrane 12 after being washed are dried at, for example, 80° C. After drying the support 11 and the zeolite membrane 12, the heat treatment is performed on the zeolite membrane 12, to thereby almost completely burn and remove the SDA in the zeolite membrane 12 and allow micropores in the zeolite membrane 12 to penetrate the zeolite membrane 12. The above-described zeolite membrane complex 1 is thereby obtained.

In the exemplary zeolite membrane complex 1 of FIG. 1, the sealing parts 13 are provided on both end portions of the support 11 in the longitudinal direction. The sealing parts 13 are members for covering and sealing both end surfaces of the support 11 in the longitudinal direction and outer surfaces in the vicinity of both the end surfaces. The sealing parts 13 prevent the inflow and outflow of gas from/to both the end surfaces of the support 11. The sealing part 13 is formed of, for example, glass, a resin, or a metal. The material and the shape of the sealing part 13 may be changed as appropriate. Furthermore, both ends of each through hole 111 in the longitudinal direction are not covered with the sealing parts 13, and therefore, the inflow and outflow of gas to/from the through hole 111 from/to both the ends thereof can be made.

In the separation membrane module 21, the housing 22 is, for example, a tubular member having a substantially cylindrical shape. The housing 22 may have any shape other than a cylindrical shape. The housing 22 is a pressure-resistant container and formed of, for example, stainless steel or carbon steel. The longitudinal direction of the housing 22 is substantially in parallel with the longitudinal direction of the zeolite membrane complex 1. A supply port 221 is provided at an end portion on one side in the longitudinal direction of the housing 22 (i.e., an end portion on the left side in FIG. 1), and a first exhaust port 222 is provided at another end portion on the other side. A second exhaust port 223 is provided on a side surface of the housing 22. The supply pipe 26 is connected to the supply port 221. The first collection pipe 27 is connected to the first exhaust port 222. The second collection pipe 28 is connected to the second exhaust port 223. An internal space of the housing 22 is a sealed space that is isolated from the space around the housing 22.

In the exemplary case shown in FIG. 1, the housing 22 includes a housing body 224 and two cover parts 226. The housing body 224 is a substantially cylindrical member having openings at both end portions in the longitudinal direction. The housing body 224 is provided with two flange parts 225. The two flange parts 225 are substantially annular disk-like portions extending radially outward from the housing body 224 around the above-described two openings of the housing body 224, respectively. The housing body 224 and the two flange parts 225 are connected members. The two cover parts 226 are fixed to the two flange parts 225 by being bolted or the like while covering the above-described two openings of the housing body 224, respectively. The two openings of the housing body 224 are thereby sealed hermetically. The above-described supply port 221 is provided in the cover part 226 on the left side in FIG. 1. The first exhaust port 222 is provided in the cover part 226 on the right side in FIG. 1. The second exhaust port 223 is provided at the substantially center of the housing body 224 in the longitudinal direction.

The two sealing members 23 are arranged around the entire circumference between an outer surface of the zeolite membrane complex 1 and an inner surface of the housing 22 in the vicinity of both end portions of the zeolite membrane complex 1 in the longitudinal direction. Each of the sealing members 23 is a member formed of a material that the gas cannot permeate. In the exemplary case shown in FIG. 1, the sealing member 23 has an annular shape and is, for example, an O-ring formed of a flexible resin.

Each sealing member 23 comes into close contact with the outer surface of the zeolite membrane complex 1 and the inner surface of the housing 22 around the entire circumferences thereof. In the exemplary case of FIG. 1, the sealing members 23 come into close contact with outer surfaces of the sealing parts 13 and indirectly come into close contact with the outer surface of the support 11 with the sealing parts 13 interposed therebetween. The portions between the sealing members 23 and the outer surface of the zeolite membrane complex 1 and between the sealing members 23 and the inner surface of the housing 22 are sealed, and it is thereby mostly or completely impossible for the gas to pass through the portions. In the separation membrane module 21, the hermeticity between the second exhaust port 223, and the supply port 221 and the first exhaust port 222 is ensured by the sealing members 23.

The supply pipe 26 connects a supply source 91 of the mixed gas and the separation membrane module 21 to each other. The supply pipe 26 is provided with, for example, a regulating valve 261 for adjusting a pressure of the mixed gas. A control part 20 is electrically connected to the regulating valve 261. The control part 20 is, for example, an electric circuit for control or a computer having a CPU and the like. The control part 20 controls the degree of opening of the regulating valve 261. There may be a configuration where the supply pipe 26 is provided with a pressure gauge and the regulating valve 261 is controlled (for example, feedback-controlled) on the basis of a value of the pressure gauge. The mixed gas flowing in the supply pipe 26 is supplied to the internal space of the housing 22 through the supply port 221. The supply pipe 26 may be provided with a blower, a pump, or the like for pumping the mixed gas toward the housing 22. The supply pipe 26 and the regulating valve 261 constitute a supply part 260 for supplying the mixed gas to the zeolite membrane complex 1.

In the first collection pipe 27, the gas exhausted from the first exhaust port 222 is collected. In the second collection pipe 28, the gas exhausted from the second exhaust port 223 is collected. The first collection pipe 27 and the second collection pipe 28 each may be provided with a storage container for storing the collected gas, or may be provided with the blower, the pump, or the like for transporting the gas.

In the separation apparatus 2, the mixed gas containing a plurality of types of gases with different permeabilities through the zeolite membrane 12 is supplied into the internal space of the housing 22 from the supply source 91 through the supply pipe 26. For example, the main components of the mixed gas are CO₂ and CH₄. The mixed gas may contain any gas other than CO₂ or CH₄. The pressure (i.e., feed pressure) of the mixed gas to be supplied into the internal space of the housing 22 from the supply pipe 26 is, for example, 0.1 MPaA (absolute pressure) to 20.0 MPaA. The temperature for separation of the mixed gas is, for example, 10° C. to 250° C.

The mixed gas supplied from the supply pipe 26 into the housing 22 is fed from the left end of the separation membrane complex 1 in FIG. 1 into the inside of each through hole 111 of the support 11 as indicated by an arrow 251. Gas with high permeability (which is, for example, CO₂, and is hereinafter referred to as a “high permeability substance”) in the mixed gas permeates the zeolite membrane 12 formed on the inner surface of each through hole 111 and the support 11, and is led out from the outer surface of the support 11. The high permeability substance is thereby separated from gas with low permeability (which is, for example, CH₄, and is hereinafter referred to as a “low permeability substance”) in the mixed gas.

The gas (hereinafter, referred to as a “permeate substance”) which has permeated the zeolite membrane complex 1 and has been led out from the outer surface of the support 11 is exhausted to the second collection pipe 28 through the second exhaust port 223 and collected therein as indicated by an arrow 253. The pressure (i.e., permeate pressure) of the gas to be exhausted to the second collection pipe 28 through the second exhaust port 223 is, for example, about 1 atmospheric pressure (0.101 MPaA).

Further, in the mixed gas, gas (hereinafter, referred to as a “non-permeate substance”) other than the gas which has permeated the zeolite membrane complex 1 passes through each through hole 111 of the support 11 from the left side to the right side in FIG. 1. The non-permeate substance is exhausted to the first collection pipe 27 through the first exhaust port 222 and collected therein as indicated by an arrow 252. The pressure of the gas to be exhausted to the first collection pipe 27 through the first exhaust port 222 is, for example, substantially the same as the feed pressure. The non-permeate substance may include a high permeability substance that has not permeated the zeolite membrane 12, as well as the above-described low permeability substance.

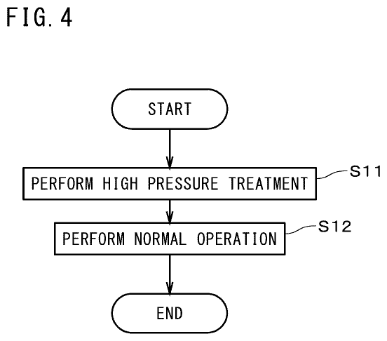

FIG. 4 is a flowchart showing a flow of operating the separation apparatus 2. In operating the separation apparatus 2, first, the supply of the mixed gas to the zeolite membrane complex 1 is started. Herein, in the separation apparatus 2, in a later-described normal operation, a criterion of the degree of opening of the regulating valve 261 for supplying the mixed gas at a constant set pressure is acquired in advance as a standard opening degree. The standard opening degree is determined experimentally or empirically. At the time of starting the supply of the mixed gas, the control part 20 opens the regulating valve 261 from a closed state up to the degree of opening not lower than the standard opening degree quickly (e.g., within 10 seconds). The mixed gas thereby vigorously flows into the housing 22 from the supply source 91 through the supply pipe 26. As a result, the pressure of the mixed gas acting on the zeolite membrane 12 becomes higher than the set pressure temporarily (e.g., for a few seconds). In other words, a high pressure treatment for supplying the mixed gas to the zeolite membrane 12 at a pressure higher than the set pressure is performed (Step S11). Furthermore, in a case where the pressure of the mixed gas varies to some degree with respect to the set pressure in the normal operation, it is preferable that the pressure in the high pressure treatment should be higher than the maximum value of the variation range.

The pressure of the mixed gas in the high pressure treatment can be adjusted by adjusting the degree of opening of the regulating valve 261 at the time of starting the supply of the mixed gas. As the degree of opening of the regulating valve 261 at the time of starting the supply becomes higher, for example, the pressure of the mixed gas in the high pressure treatment becomes higher. Also in the case where the regulating valve 261 is quickly opened from the closed state up to the standard opening degree at the time of starting the supply of the mixed gas, the pressure of the mixed gas acting on the zeolite membrane 12 temporarily becomes higher than the set pressure. Further, the time for the high pressure treatment can be also adjusted by adjusting the degree of opening of the regulating valve 261. As the time in which the degree of opening of the regulating valve 261 is made higher than the standard opening degree becomes longer, for example, the time for the high pressure treatment becomes longer. With the above-described operation, the same effect as in the high pressure treatment is produced even in an operation in which the set pressure is changed for a short time. Thus, at the time of starting the supply of the mixed gas to the zeolite membrane 12, by performing the high pressure treatment for intentionally causing an overshoot, unnecessary substances (moisture and hydrocarbon components or the like in the air) deposited onto the zeolite membrane 12 can be removed.

In a case where the regulating valve 261 is controlled on the basis of a value of the pressure gauge, at the time of starting the supply of the mixed gas, by using the fact that time is required until the pressure is stabilized due to a delay of the response of the regulating valve 261, the overshoot of the pressure of the mixed gas may be caused. The overshoot of the pressure of the mixed gas may be caused by a delay of the response of any equipment other than the regulating valve 261. Further, the high pressure treatment may be performed by gently opening the regulating valve 261 from the closed state up to the degree of opening higher than the standard opening degree at the time of starting the supply of the mixed gas. Also in this case, during a period when the degree of opening is higher than the standard opening degree, the pressure of the mixed gas acting on the zeolite membrane 12 is higher than the set pressure and the unnecessary substances deposited onto the zeolite membrane 12 are removed. Furthermore, the regulating valve 261 may be controlled on the basis of the value of the pressure gauge so that the pressure of the mixed gas can become higher than the set pressure. The high pressure treatment may be performed, accompanying the start of the supply of the mixed gas, as well as performed simultaneously with the start of the supply of the mixed gas.

The pressure of the mixed gas during the high pressure treatment is, for example, not higher than 10 times the set pressure. It is thereby possible to more surely prevent a damage of the separation apparatus 2 due to an excessively high pressure. The pressure of the mixed gas during the high pressure treatment is, for example, not lower than 1.1 times the set pressure, preferably not lower than 1.2 times, more preferably not lower than 1.3 times, and further preferably not lower than 1.5 times. The time for the high pressure treatment, i.e., the time in which the pressure of the mixed gas is maintained to be higher than the set pressure is, for example, 0.1 to 10000 seconds. In order to more surely remove the unnecessary substances deposited onto the zeolite membrane 12, the time for the high pressure treatment is preferably not shorter than 1 second, more preferably not shorter than 3 seconds, and further preferably not shorter than 5 seconds. In order to reduce the time required to remove the unnecessary substances, the time for the high pressure treatment is preferably not longer than 300 seconds, more preferably not longer than 100 seconds, and further preferably not longer than 30 seconds. Further, in the high pressure treatment, separation of the high permeability substance is performed in parallel.

In the high pressure treatment, in a case where a life consumption rate [%] in one high pressure treatment is obtained by substituting a ratio (pressure during the high pressure treatment/breakdown pressure) of a pressure during the high pressure treatment to a later-described breakdown pressure which is a pressure at which the zeolite membrane 12 is broken down in a short time for A in Eq. 2 and substituting the time for the high pressure treatment for t, it is preferable that the life consumption rate should be not higher than 0.1%. The life consumption rate is preferably not higher than 0.01%, and more preferably not higher than 0.001%. It is thereby possible to appropriately suppress life consumption, as described later. A lower limit of this life consumption rate is not particularly limited (higher than 0%). Derivation of Eq. 2 will be described later.

$$( Eq . 2 )$$

$$life consumption rate in one high pressure treatment = \frac{t}{{A}^{a} \times {10}^{b}} \times 100$$

When the pressure is not constant in the high pressure treatment (for example, when the overshoot described earlier is caused), it is preferable that a value obtained by dividing the maximum pressure in the high pressure treatment by the breakdown pressure should be substituted for A in Eq. 2. In this case, an actual life consumption rate is lower than the life consumption rate obtained from Eq. 2. The pressure in the high pressure treatment (the above-described maximum pressure) is measured, for example, by the pressure gauge provided in the supply pipe 26. In a case where the high pressure treatment is performed under certain conditions, when the pressure in the high pressure treatment under these conditions is known, the life consumption rate may be obtained by using the known pressure, instead of measuring the pressure. The same applies to the time for the high pressure treatment.

When the high pressure treatment is completed, the normal operation of the separation apparatus 2 is performed (Step S12). In the normal operation, the pressure of the mixed gas acting on the zeolite membrane 12 is made to be a constant set pressure, and in this state, the high permeability substance in the mixed gas is separated from the low permeability substance. The set pressure is preferably 0.1 MPaG (gauge pressure) to 8 MPaG. Since the unnecessary substances deposited onto the zeolite membrane 12 are removed in the high pressure treatment, the permeance of the high permeability substance through the zeolite membrane complex 1 increases.

As described earlier, the standard opening degree is a criterion of the degree of opening of the regulating valve 261 for supplying the mixed gas at the set pressure, and in the normal operation, the regulating valve 261 is adjusted to be almost the standard opening degree. In a case where the degree of opening of the regulating valve 261 at the time of starting the supply of the mixed gas is made to be the standard opening degree, since a flow of the mixed gas in the supply pipe 26 becomes a steady state after starting the supply of the mixed gas, the pressure of the mixed gas becomes the set pressure. The regulating valve 261 may be controlled on the basis of the value of the pressure gauge so that the pressure of the mixed gas can become the set pressure.

In a case where the normal operation is stopped due to maintenance or the like of the separation apparatus 2, after the maintenance or the like is finished, when the normal operation is restarted, it is preferable that the same process as in above-described Step S11 should be performed. In other words, at the time of starting the supply of the mixed gas to the zeolite membrane 12 in restarting the normal operation, like in the above-described operation, the high pressure treatment is performed. Further, there may be a case where by temporarily making the degree of opening of the regulating valve 261 higher than the standard opening degree in the middle of the normal operation, the high pressure treatment is performed and the unnecessary substances deposited onto the zeolite membrane 12 are thereby removed. Also in this case, it is preferable that the pressure during the high pressure treatment and the time for the high pressure treatment should be determined so that the life consumption rate [%] in one high pressure treatment can be not higher than 0.1%.

Herein, the life consumption rate of the zeolite membrane 12 will be described. In operating the separation apparatus 2, an experiment for using the equation (above-described Eq. 2) of the life consumption rate in the high pressure treatment is performed in advance. Specifically, a plurality of zeolite membrane complexes produced under the same condition as in the production of the zeolite membrane complex 1 provided in the separation apparatus 2 are prepared. Each zeolite membrane complex is put into a furnace and a zeolite membrane is reproduced by heating. In reproduction of the zeolite membrane, for example, the temperature is raised from a room temperature to 380° C. in 15.2 hours (rate of temperature rise is 25° C./hr) in the air atmosphere, maintained at 380° C. for 8 hours, and lowered to the room temperature in 15.2 hours (rate of temperature fall is 25° C./hr). The unnecessary substances (moisture and hydrocarbon components or the like in the air) deposited onto the zeolite membrane 12 are thereby removed.

The zeolite membrane complex is taken out from the furnace and housed into the housing 22 shown in FIG. 1. Then, a gas separation measurement is performed by using the zeolite membrane complex. In the gas separation measurement, for example, a mixed gas in which CO₂ and CH₄ are mixed at 50:50 (volume ratio) is used. Further, in the measurement, the temperature is 25° C., the feed pressure is 0.3 MPaG, and the permeate pressure is 0 MPaG. Then, from the permeate substance exhausted from the second exhaust port 223, the CO₂ permeance and the CH₄ permeance are acquired, and a ratio (CO₂ permeance/CH₄ permeance) of the CO₂ permeance to the CH₄ permeance is obtained as a separation ratio. The separation ratio is a separation ratio before applying a later-described pressure, and hereinafter, is referred to as an “initial separation ratio”.

Subsequently, a pressure is applied to the zeolite membrane. In application of the pressure, water is supplied from the supply port 221 into the housing 22 at a constant pressure and the pressure is applied to the zeolite membrane of the zeolite membrane complex. After the pressure is applied to the zeolite membrane for a predetermined time, the zeolite membrane complex is taken out from the housing 22. The zeolite membrane complex is put into the furnace, and the zeolite membrane is reproduced by heating, like in the above-described operation. After the zeolite membrane is reproduced, the gas separation measurement is performed and a separation ratio after application of the pressure is obtained.

For each zeolite membrane complex, the above-described application of the pressure, the reproduction of the zeolite membrane by heating, and the gas separation measurement are repeated. At that time, the pressure applied to one zeolite membrane complex is constant and the application time of the applied pressure is changed as appropriate. Further, among the plurality of zeolite membrane complexes, the applied pressures are different. When the separation ratio after applying the pressure becomes not higher than 0.1 times the initial separation ratio, it is determined that the zeolite membrane of the zeolite membrane complex reaches the end of the life, and the sum of the application times of the applied pressure till the point in time is determined as a life time of the zeolite membrane at the applied pressure. In the present experiment, very high applied pressure is also used, and the applied pressure at which the life time becomes not longer than 1 second is acquired as a breakdown pressure (also referred to as an “internal-pressure breakdown strength”). Further, in a case where the life time becomes not longer than 1 second at the plurality of applied pressures, for example, the minimum applied pressure is determined as the breakdown pressure. Thus, with respect to the zeolite membrane 12, the life time and the breakdown pressure at each applied pressure are acquired.

Subsequently, assuming that a ratio (applied pressure/breakdown pressure) of each applied pressure to the breakdown pressure is A and the life time at the applied pressure is L [second], in a case where a relation between the ratio A and the life time L is expressed as log₁₀ L=a log₁₀ A+b, respective values of a and b are obtained by the least-squares method. In other words, in a double logarithmic graph where the vertical axis represents log L and the horizontal axis represents log A, a slope “a” and an intercept “b” of an approximate straight line representing a relation between log L and log A are obtained. Values of a and b are eigenvalues derived from the type, the structure, or the like of the zeolite membrane.

The above-described equation can be transformed as L=A^{a}×10^{b}. Further, the life consumption rate [%] in one high pressure treatment is a ratio of the time t for one high pressure treatment to the life time L and can be obtained from (t/L)×100. By substituting L=A^{a}×10^{b} into this expression, the life consumption rate [%] in one high pressure treatment is expressed as above-described Eq. 2. As described earlier, A in Eq. 2 represents the ratio of the pressure in the high pressure treatment to the breakdown pressure. In a case where the high pressure treatment is performed N times (N is an integer not less than 1) with the same pressure in the high pressure treatment and the same time for the high pressure treatment, the life consumption rate [%] in N high pressure treatments is expressed as Eq. 3.

$$( Eq . 3 )$$

$$life consumption rate in N high pressure treatments = \frac{t}{{A}^{a} \times {10}^{b}} \times 100 \times N$$

Next, with reference to Table 1, Experimental Examples 1 to 8 of the high pressure treatment will be described. In Experimental Examples 1 to 8, the pressure in the high pressure treatment and the time for the high pressure treatment are changed. In Table 1, “Pressure Magnification” represents a ratio of the pressure in the high pressure treatment to the set pressure in the normal operation and “Pressure Time” represents a time for the high pressure treatment. Further, since the set pressure is different in accordance with the state of the supply source or the like, the set pressure in Experimental Examples 1 to 5 and 7 and that in Experimental Examples 6 and 8 are different from each other. “A” represents the ratio of the pressure in the high pressure treatment to the breakdown pressure and “Number of Times” represents the number of times at which the high pressure treatment is performed. “Life Consumption Rate” is the life consumption rate including the number of times and obtained from Eq. 3.

TABLE 1

| | | | | | Life | Relative | Relative |
|---|---|---|---|---|---|---|---|
| | Pressure | Pressure | | Number | Consumption | CO₂ | Separation |
| | Magnification | Time | A | of | Rate | Permeance | Ratio |
| | [—] | [s] | [%] | Times | [%] | [%] | [%] |
| Experimental | 9.0 | 10 | 55 | 1 | 0.0000045 | 139 | 104 |
| Example 1 | | | | | | | |
| Experimental | 6.0 | 10 | 37 | 1 | 0.0000000 | 135 | 102 |
| Example 2 | | | | | | | |
| Experimental | 3.0 | 10 | 18 | 1 | 0.0000000 | 130 | 101 |
| Example 3 | | | | | | | |
| Experimental | 1.1 | 10 | 7 | 1 | 0.0000000 | 125 | 101 |
| Example 4 | | | | | | | |
| Experimental | 3.0 | 1000 | 18 | 1 | 0.0000000 | 132 | 102 |
| Example 5 | | | | | | | |
| Experimental | 9.0 | 10 | 83 | 1 | 2.1905248 | 142 | 97 |
| Example 6 | | | | | | | |
| Experimental | 9.0 | 10000000 | 55 | 1 | 4.4775413 | 141 | 98 |
| Example 7 | | | | | | | |
| Experimental | 9.0 | 1000 | 83 | 1 | 219.05248 | 161 | 18 |
| Example 8 | | | | | | | |
| Reference | 1.0 | 0 | 6 | 1 | — | 100 | 100 |
| Example 1 | | | | | | | |

In Experimental Examples 1 to 8, the permeance of CO₂ after the high pressure treatment is also measured. In the measurement of the permeance, a mixed gas in which CO₂ and CH₄ are mixed at 50:50 (volume ratio) is used, and in the measurement, the temperature is 25° C., the feed pressure is 0.3 MPaG, and the permeate pressure is 0 MPaG. In Table 1, “Relative CO₂ Permeance” represents a ratio of the CO₂ permeance after the high pressure treatment to the CO₂ permeance in Reference Example 1 in which no high pressure treatment is performed. “Relative Separation Ratio” represents a ratio of the separation ratio after the high pressure treatment to the separation ratio in Reference Example 1.

In each of Experimental Examples 1 to 8 in which the high pressure treatment is performed, the relative CO₂ permeance is higher than 100% and the permeability of the zeolite membrane is improved. In Experimental Examples 1 to 4 in which the same set pressure and the same pressure time are used, the relative CO₂ permeance increases as the pressure magnification becomes higher. Further, in each of Experimental Examples 1 to 4, the relative separation ratio is not lower than 100. In Experimental Example 5, though the pressure time in Experimental Example 3 is extended 100 times, the life consumption rate is lower than 0.1% and the relative separation ratio is not lower than 100. In Experimental Example 6, since the pressure magnification and the pressure time are the same as those in Experimental Example 1 but the ratio A is large, the life consumption rate becomes significantly larger than 0.1%. In Experimental Example 7, since the pressure magnification and the ratio A are the same as those in Experimental Example 1 but the pressure time is extended 1000000 times, the life consumption rate becomes significantly larger than 0.1%. In Experimental Examples 6 and 7, the relative separation ratio becomes lower than 100. In Experimental Example 8, as a result of extending the pressure time in Experimental Example 6 100 times, the life consumption rate becomes over 100% and the relative separation ratio becomes significantly lower.

As described above, the method of operating the separation apparatus 2 includes a step (Step S12) of performing a normal operation for supplying a mixed gas containing a plurality of types of gases to a separation membrane (the zeolite membrane 12 in the above-described exemplary case) at a constant set pressure, to thereby separate a substance in the mixed gas, which has high permeability through the separation membrane, from any other substance and a step (Step S11) of performing a high pressure treatment for supplying the mixed gas to the separation membrane at a pressure higher than the set pressure at the time of starting supply of the mixed gas to the separation membrane before the normal operation or in the middle of the normal operation.

Herein, in the conventional method of operating the separation apparatus, since the regulating valve 261 is gently opened from the closed state up to the standard opening degree at the time of starting the supply of the mixed gas, the pressure of the mixed gas gradually increases up to the set pressure. In other words, the state where the mixed gas is supplied to the separation membrane at a pressure higher than the set pressure is not achieved. Further, in the normal operation, the pressure of the mixed gas is maintained at the constant set pressure. In contrast to this, in the above-described method of operating the separation apparatus 2, the pressure of the mixed gas is intentionally made to be a pressure higher than the set pressure at the time of starting the supply of the mixed gas to the separation membrane or in the middle of the normal operation.

It is thereby possible to remove the unnecessary substances deposited onto the separation membrane by using the mixed gas to be processed and easily improve the permeability of the separation membrane (improve the permeance of the high permeability substance) without using a heater or any gas other than the mixed gas. Furthermore, with the improvement of the permeability of the separation membrane, it becomes possible to reduce the number of separation membrane complexes provided in the separation apparatus 2.

Preferably, in a case where a relation between the ratio A of the applied pressure to the breakdown pressure and the life time L at the applied pressure in the separation membrane is expressed as log₁₀ L=a log₁₀ A+b, values of a and b are obtained in advance. Then, the life consumption rate [%] in one high pressure treatment, which is obtained by substituting the ratio of the pressure during the high pressure treatment to the breakdown pressure for A in above-described Eq. 2 using the values of a and b and substituting the time for the high pressure treatment for t, is not higher than 0.1%. It is thereby possible to appropriately suppress the life consumption (damage) of the separation membrane during the high pressure treatment, and even in a case where the high pressure treatment is repeated, it becomes possible to maintain high relative separation ratio and prolong the life time of the separation membrane. As a result, it becomes possible to extend a replacement cycle of the separation membrane complex (in other words, possible to reduce the number of replacements of the separation membrane complex in a predetermined period).

Preferably, in the separation apparatus 2, the regulating valve 261 is provided between the supply source 91 of the mixed gas and the separation membrane. The standard opening degree of the regulating valve 261 for supplying the mixed gas to the separation membrane at the set pressure is acquired in advance, and the degree of opening of the regulating valve 261 is adjusted to the degree of opening not lower than the standard opening degree at the time of starting the supply of the mixed gas to the separation membrane. It is thereby possible to easily perform the high pressure treatment without providing a booster or the like in the supply pipe 26, and as a result, it is possible to ensure space saving as compared with the case where the booster or the like is provided. Depending on the pressure of the mixed gas to be supplied from the supply source 91, or the like, the booster or the like may be provided in the supply pipe 26.

Preferably, the above-described set pressure is 0.1 to 8 MPaG and the pressure during the high pressure treatment is not higher than 10 times the set pressure. It is thereby possible to prevent a damage of the separation apparatus 2 due to the use of an excessively high pressure in the high pressure treatment.

Preferably, the time for the high pressure treatment is 0.1 to 10000 seconds. It is thereby possible to remove the unnecessary substances deposited onto the separation membrane in a short time as compared with the case where the separation membrane complex is taken out from the housing 22 and heated inside the furnace, like in the above-described reproduction of the zeolite membrane by heating.

Preferably, the separation membrane is the zeolite membrane 12. It is thereby possible to appropriately perform separation of the mixed gas. Further, in the case where the maximum number of membered rings of a zeolite forming the zeolite membrane 12 is 8, it is possible to appropriately achieve selective permeate of a substance having a relatively small molecular diameter.

The separation apparatus 2 includes the separation membrane (the zeolite membrane 12 in the above-described exemplary case), the supply part 260 for supplying the mixed gas to the separation membrane, to thereby perform separation of the mixed gas, and the control part 20 for controlling the supply part 260 to perform the normal operation for supplying the mixed gas to the separation membrane at the constant set pressure and perform the high pressure treatment for supplying the mixed gas to the separation membrane at a pressure higher than the set pressure at the time of starting the supply of the mixed gas to the separation membrane before the normal operation or in the middle of the normal operation. It is thereby possible to remove the unnecessary substances deposited onto the separation membrane and easily improve the permeability of the separation membrane.

In the method of operating the separation apparatus 2 and the separation apparatus 2 described above, various modifications can be made.

In a case where the number of high pressure treatments performed on the zeolite membrane 12 is small, or the like case, the life consumption rate [%] in one high pressure treatment may be higher than 0.1%. Depending on the configuration or the like of the separation apparatus 2, the set pressure may be higher than 8 MPaG, and the pressure during the high pressure treatment may be higher than 10 times the set pressure. Further, the time for the high pressure treatment may be longer than 10000 seconds.

The supply of the mixed gas to the zeolite membrane 12 at a pressure higher than the set pressure may be achieved, for example, by using the blower, the booster, or the like provided in the supply pipe 26, as well as by adjusting the degree of opening of the regulating valve 261.

In the zeolite membrane complex 1, the zeolite membrane 12 may be formed on the outer surface of the support 11. As described earlier, the support 11 may be one of any type other than monolith-type.

The zeolite membrane complex 1 may further include a function layer or a protective layer laminated on the zeolite membrane 12, additionally to the support 11 and the zeolite membrane 12. Such a function layer or a protective layer may be an inorganic membrane such as the zeolite membrane, a silica membrane, a carbon membrane, or the like or an organic membrane such as a polyimide membrane, a silicone membrane, or the like. Further, a substance that is easy to adsorb specific molecules such as CO₂ or the like may be added to the function layer or the protective layer laminated on the zeolite membrane 12.

The type of zeolite forming the zeolite membrane 12 may be changed as appropriate, and the maximum number of membered rings of the zeolite may be any number other than 8. As described earlier, the separation membrane may be any membrane other than the zeolite membrane 12.

In the separation apparatus 2 using the separation membrane, a substance other than those exemplarily shown in the above description may be separated from the mixed gas.

The configurations in the above-described preferred embodiment and variations may be combined as appropriate only if those do not conflict with one another.

While the invention has been shown and described in detail, the foregoing description is in all aspects illustrative and not restrictive. It is therefore understood that numerous modifications and variations can be devised without departing from the scope of the invention.

### Industrial Applicability

The method of operating a separation apparatus and the separation apparatus in accordance with the present invention can be used in various fields using a separation membrane.

### REFERENCE SIGNS LIST

2 Separation apparatus
12 Zeolite membrane
20 Control part
260 Supply part
S11, S12 Step

1. A method of operating a separation apparatus using a separation membrane, comprising:
performing a normal operation for supplying a mixed gas containing a plurality of types of gases to a separation membrane at a constant set pressure, to thereby separate a substance in said mixed gas, which has high permeability through said separation membrane, from any other substance; and
performing a high pressure treatment for supplying said mixed gas to said separation membrane at a pressure higher than said set pressure at a time of starting supply of said mixed gas to said separation membrane before said normal operation or in a middle of said normal operation.

2. The method of operating a separation apparatus according to claim 1, wherein
in a case where a relation between a ratio A of an applied pressure to a breakdown pressure and a life time L at said applied pressure in said separation membrane is expressed as log₁₀ L=a log₁₀ A+b, values of a and b are obtained in advance, and
a life consumption rate [%] in one high pressure treatment, which is obtained by substituting a ratio of a pressure during said high pressure treatment to said breakdown pressure for A in a following equation using said values of a and b and substituting a time for said high pressure treatment for t, is not higher than 0.1%.
$$( Eq . 1 )$$
$$life consumption rate in one high pressure treatment = \frac{t}{{A}^{a} \times {10}^{b}} \times 100$$

3. The method of operating a separation apparatus according to claim 1, wherein
said set pressure is 0.1 to 8 MPaG, and
said pressure during said high pressure treatment is not higher than 10 times said set pressure.

4. The method of operating a separation apparatus according to claim 1, wherein
said time for said high pressure treatment is 0.1 to 10000 seconds.

5. The method of operating a separation apparatus according to claim 1, wherein
said separation membrane is a zeolite membrane.

6. The method of operating a separation apparatus according to claim 5, wherein
the maximum number of membered rings of a zeolite forming said zeolite membrane is 8.

7. A separation apparatus, comprising:
a separation membrane;
a supply part for supplying a mixed gas containing a plurality of types of gases to said separation membrane, to thereby separate a substance in said mixed gas, which has high permeability through said separation membrane, from any other substance; and
a control part for controlling said supply part to perform a normal operation for supplying said mixed gas to said separation membrane at a constant set pressure and perform a high pressure treatment for supplying said mixed gas to said separation membrane at a pressure higher than said set pressure at a time of starting supply of said mixed gas to said separation membrane before said normal operation or in a middle of said normal operation.
